(19) United States
(12) Patent Application Publication
(10) Pub. No.: US 2006/0175270 A1
(43) Pub. Date: Aug. 10, 2006

(54) Compact backwashable water filter system

(76) Inventor: William A. Greene, Los Angeles, CA (US)

Correspondence Address: LEON D. ROSEN;FREILICH, HORNBAKER & ROSEN, SUITE 1220, 10960 Wilshire Blvd., Los Angeles, CA, 90021, US

(21) Appl. No.: 11/340,373

(22) Filed: Jan. 26, 2006

Related U.S. Application Data
(60) Provisional application No. 60/648,310, filed on Jan. 28, 2005.

(51) Int. Cl. B01D 29/62

(52) U.S. Cl. 210/798; 210/411

(57) ABSTRACT

A water filter system (10) for home use, includes a valve (34) that passes pressured water from a municipal water supply (30) though the inlet (20) of a passage (14) containing bidirectional filter elements (16) so the water has to pass though the filter elements to reach an outlet (22) that leads to a faucet (24). A water pressuring device (52) such as one that includes a bladder (56), has one side that faces a water outlet storage region (54) and an opposite side that faces a pressing apparatus such as compressed air (64). At intervals such as every 24 hours at 3:00 a.m., a timer (70) operates the control valve to connect the inlet (20) to a drain (50) instead of to the municipal water supply, for a period such as 20 seconds. Then, water backflushes though the bidirectional filter elements to a drain, to clean the filter elements. An ultraviolet light (104) at the outlet storage region kills bacteria to prevent bacteria buildup in the outlet region.

### CROSS-REFERENCE

Applicant claims priority from U.S. provisional application 60/648,310 filed Jan. 28, 2005.

### BACKGROUND OF THE INVENTION

Many municipal water supplies provide water that does not taste good, that is not reliably safe to drink, or that people do not trust, and many people wish to pass water from the municipal water supply though a filter system. Presently available filter systems should be cleaned at intervals such as every day or every several days to avoid the buildup of bacteria. Some systems recommend that people clean the filters every several days and replace them at intervals , but many people do not do such cleaning or replacement on a regular basis. This can result in bacteria growing in the system that makes the water unhealthy or unsafe. A water filter system that cleaned itself at regular intervals without requiring human intervention, and that was of simple construction and used a minimum of water, would be of value.

### SUMMARY OF THE INVENTION

In accordance with one embodiment of the invention, a water filter system is provided that is of simple construction and that is self cleaning. The system includes a valve structure that can carry pressured feed water such as from a municipal water supply, to a passage containing a bidirectional filter arrangement such as hollow fibers with microscopic pores. The water flows forward through the hollow fibers to an outlet storage region from which water can be drawn to flow to a faucet, nozzle or other flow control. A water pressurizing device, such as a bladder having one side facing the water outlet storage region and an opposite side facing a pressured air chamber, maintains water in the outlet storage region under pressure. At intervals such as every 24 hours, in the middle of the night, a timer operates the valve structure to open a connection to a drain, for a period such as 20 seconds. Then, water in the outlet storage region is moved by the bladder in a reverse or backward direction though the bidirectional filter elements to the drain. This results in a backwashing of the filter elements and of the passage, to eliminate debris, which may include bacteria, that has accumulated on the filter elements and in the passage. The filter elements are preferably small diameter porous plastic tubes with very small pores or with a coating of a filtering layer such as polysulfone.

One water filtration system includes a water pressuring device that contains only enough water in the outlet storage region to clean the filter elements and passage by backflushing. The output of water from the system is then limited by the flow rate of water though the filtering elements. A second water filtration system includes a water pressuring device that stores much more water than is required for flushing. This allows a person to open the faucet and rapidly withdraw water at a rate much faster than water can pass though the filter elements, until the store of water has been exhausted. Where a lot of water is stored, auxiliary filters such as carbons filter cylinders, can lie within the water storage volume.

In another system, backflushing is enhanced by allowing pressured feed water to flow across the outside of the fibers while filtered water in the outlet storage region flows backward through the fibers to their outer surfaces to clean the pores in the fibers. The filtered water that has cleaned the fiber pores then flow out with the pressured feed water to the drain.

Water in the water pressuring device is kept clean, even if it lies dormant in a concave wall, by an ultraviolet light that shines such light at the outlet region.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a sectional side elevation view of a water filter system of the invention.

FIG. 2 is a partially sectional isometric view of a portion of the system of FIG. 1.

FIG. 3 is an enlarged view showing the way a fiber end is mounted.

FIG. 4 is a sectional view of a group of fibers of the system of FIG. 1.

FIG. 5 is a partially sectional isometric view of a water filtration system of another embodiment of the invention.

FIG. 6 is a sectional side view of a water filter system of another embodiment of the invention.

### DESCRIPTION OF THE PREFERRED EMBODIMENTS

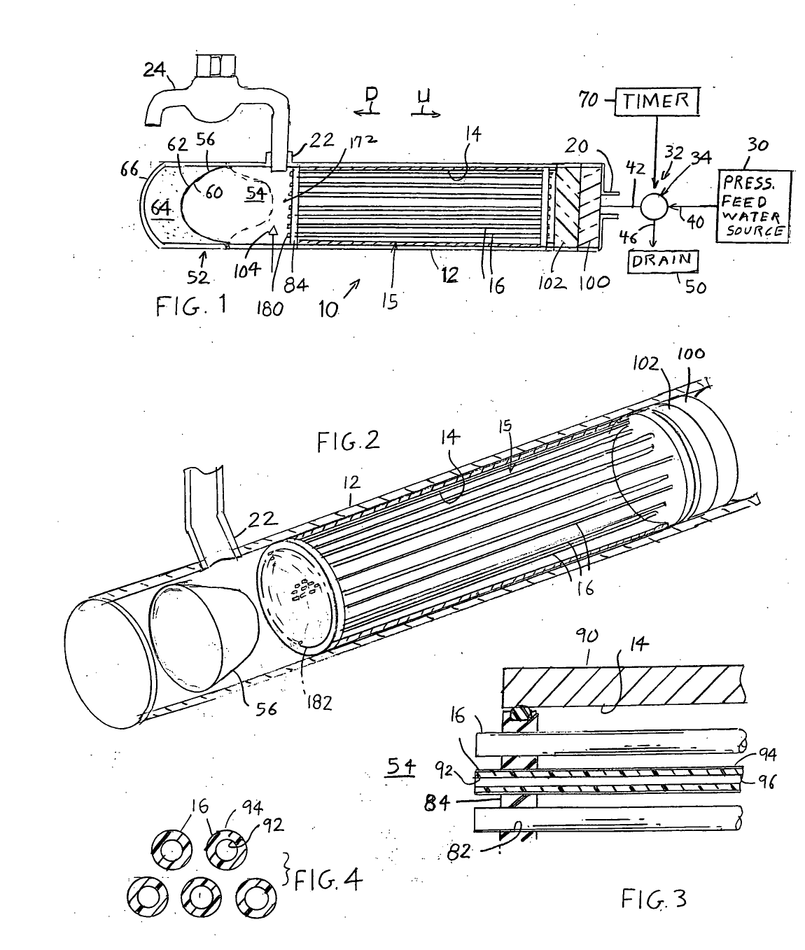

FIGS. 1-4 illustrate a water filter system 10 for home, office, or the like which includes a conduit 12 and walls forming a filter passage 14 of the conduit that surrounds a filter arrangement 15 that includes a plurality of filter elements 16, such as tubular filters. The conduit has an inlet 20 that receives feed water to be filtered and has an outlet 22 for dispensing filtered water. The outlet is shown connected to a faucet 24 such as a household faucet that dispenses water for drinking or cooking. Feed water is received from a pressured feed water source 30 such as a municipal water system. The water flows though a valve structure 32 formed by a three-way valve 34 (or two 2-way valves). In the usual mode of operation, but with the faucet closed, the pressure of the feed water is maintained throughout the passage 14 but there is no water flow. In the usual mode of operation, but with the faucet opened so outflow from the outlet is unobstructed, feed water flows from a feed port 40 of the valve to a common port 42 of the valve that connects to the inlet 20. The feed water flows downstream D into the filter passage 14 and forward through the filter elements to an outlet storage region 54. In the outlet storage region 54, a quantity of water is stored under pressure, and filtered water can flow out though the outlet 22 to flow to the faucet.

The valve 34 includes a drain port 46 that connects to a drain 50 such as a sink drain. A water pressure device 52 stores water in the outlet storage region 54 that lies adjacent to the outlet 22, at a pressure equal to the pressure of water in the feed water source 30, when water is not exiting the outlet. The particular water pressure device 52 includes a bladder 56 with one face 60 in contact with water in the outlet storage region 54 and an opposite face 62 in contact with pressured air 64 in a tank 66. In the usual mode of operation and with the faucet closed, the bladder is held deflected in direction D by the pressure of water in the inlet and outlet regions, and air 64 in the tank 66 is under the same pressure. A municipal water supply usually supplies water under a pressure of 10 to 100 psi, such as 50 psi.

When the system is in the usual mode of operation and with the faucet closed, the valve 34 may be switched to a backflush mode, wherein the common port 42 of the valve is connected to the drain port 46 and therefore to the drain 50. In the backflush mode, water under pressure in the outlet storage region 54 flows upstream U and backward through filter elements 16 in the passage 14 and into the passage 14, out through the inlet 20, and though the valve drain port 46 to the drain 50. There is zero water pressure in the drain 50 (plus any head pressure required to reach upward to a drain end), while there is considerable water pressure in the water pressurizing device 52. The water pressure in the outlet storage region 54 decreases as water flows upstream U, but the pressure is still high enough to assure that there will be a backflush. It is desirable but not necessary that the volume of water flowing upstream though the passage equal the volume of the passage, especially if such backflushing is performed often.

Operation of the valve 34 is controlled by a control in the form of an electronic timer 70. The timer may switch the valve 34 to the backflush mode for a short period of time such as 10 to 30 seconds, which is long enough to allow a large portion, usually a majority, of water stored in the relatively small water pressurizing device 52 to be backflushed. Applicant sets the timer so it switches the valve 34 to the backflush mode and then back to the usual mode every day at a time when it is very unlikely that the faucet 24 will be opened. The backflush time is between 11:00 PM one day and 7:00 AM the next day, and is preferably about 2:00 AM to 3:00 AM. If the faucet is open when the system is in a backflush mode, then a complete backflush will not occur, and the water pressure at the faucet will quickly drop until the system returns to the normal mode. However, occasionally missing a backflush will not noticeably affect the system. The system should be switched to the backflush mode at least once a week, and preferably once a day. The timer can run on batteries, because it operates briefly only once a day, although the municipal electric system is preferred, to energize ultraviolet lights. Other automatic or manually controlled devices can initiate each backwash.

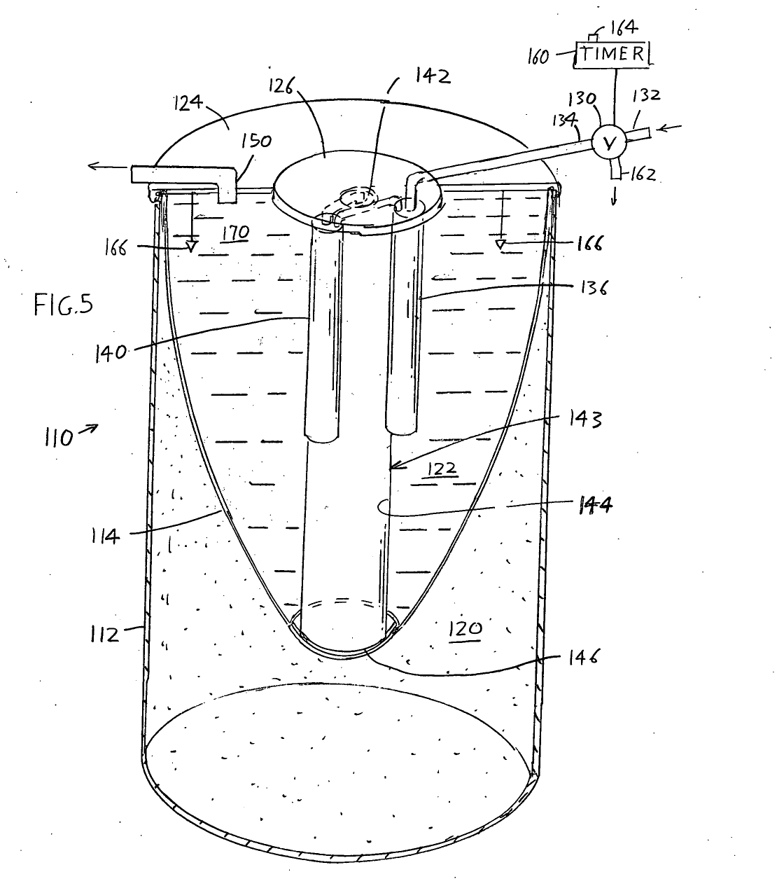

FIGS. 3 and 4 show that the filter elements 14 are in the form of tubular fibers with the distance between adjacent fibers being less than the outside diameter of each fiber. Each fiber is made of a material that is porous to water. The pores are micro (less than 1 micron), ultra (less than 0.1 micron), or nano. Applicant prefers a fiber material with pores between 1.0 and 0.01 microns for good filtration with a moderate flow rate. It is also possible to use a fiber with large pores and with a coating lying on the inside or outside and having small pores. Applicant prefers to mount the downstream ends of the fibers as shown in FIG. 3, with the downstream ends extending though holes 82 of an adhesive (e.g. epoxy) disc 84 that seals itself to the fibers and to the inside of a pipe 90 that forms the passage 14. The inside of the upstream ends of the tubular fibers are blocked, so water in the passage 14 that lies around the fibers must pass forwardly from the outside of the fibers through the walls of the fibers (including any fiber coating) to the inside of the fibers and along the passageways at the inside, to reach the outlet storage region 54. The forward flow can instead be from the inside of the fibers to their outside. A screen (not shown) can be placed upstream of the inlet to block moderately small particles, such as particles above 5 microns diameter.

FIGS. 1 and 2 show that the passage 14 preferably contains auxiliary filters 100, 102 such as a filter disc 100 that blocks very small particles (e.g. about 0.5 microns) and a disk 102 of carbon that absorbs many chemical substances (or e.g. a specialized disc for absorbing arsenic). Each auxiliary filter 100, 102 includes a bed of contaminant retainer material and a multiplicity of pores. The bed material can be chosen to filter out contaminants present in large amounts in a particular locality. The filter discs can lie at either end of the passage 14. The fiber filter elements 16 are bidirectional in that water to be further filtered can flow from its outer surface 94 to its inner surface 96, or in the opposite direction.

Applicant provides an ultraviolet light source 104 at the outlet storage region 54. The purpose is to kill bacteria, or other potentially harmful particles that might grow in static water areas of the outlet region. In the passage 14, up to the downstream mount disc 84, water is backflushed so the buildup of bacteria is less likely.

Applicant has designed a water filter system of the type shown in FIGS. 1-4. The passage 14 had an inside diameter of three inches and a length of twelve inches, for a volume of about eighteen cubic inches, or about one-eighth gallon. The water pressure device 52 had a holding capacity in the outlet storage region that was less than half the volume of the passage 14. The passage 14 held a bundle of about 2000 fibers, each having an outside diameter of 0.050 inch. The flowthrough rate of water was 0.5 gallon per minute. Applicant prefers to use on the order of magnitude of 2000 fibers.

FIG. 5 illustrates another water filter system 110 which is characterized by its ability to store considerable filtered water of at least one-half gallon such as 5 gallons. The system 110 includes a bladder tank 112 and a bladder 114 in the tank, with pressured air 120 on one side of the bladder and filtered water 122 on the other side that forms an outlet storage region 170. The tank has a top that is sealed by a main cover 124, and by a small access cover 126 within the main cover. Pressured feed water from a municipal supply passes though a valve structure formed by a three way valve 130 similar to that of FIG. 1. The pressured water passes though a feed water port 132 and a common port 134 to flow though an initial filter element 136 that traps microscopic particles (particles of 1 micron to 0.01 micron). The water then flows through a filter element 140 (e.g. carbon) that traps chemicals. The water then flows from the filter 140 into an upstream end 142 of a filter arrangement 143 (or from the filter arrangement 143 to the filters 136, 140). The water flows through a passage 144 of the filter arrangement that contains filter elements in the form of fibers similar to those of FIG. 1. Water that has flowed forward though the fibers exits the passage though an exit 146 that leads to the water side of the bladder 114. A cup 146 with a hole at its center is fixed to the bladder to distribute forces from the bladder to the exit end of the filter arrangement. The bladder is intended to expand below the exit end of the filter arrangement. Water under pressure exits the bladder though an outlet 150 whenever a faucet is opened that is attached to the outlet.

In the usual mode of operation, water flows slowly into the bladder until the pressure of air against the bladder at 120 equals the pressure of water supplied by the water source 30, and the bladder then can be said to be full. The bottom of the tank which contains air can be initially pressured so the bladder holds a predetermined amount of water, such as five gallons, when the bladder is full (assuming a predetermined municipal water pressure). Whenever a person opens the faucet, water flows rapidly out of the faucet. In one example, the filter arrangement has a flow capacity of 0.25 gallons per minute. A person can fully open the faucet and withdraw water at a rate of two gallons per minute for almost three minutes, with the water coming from the reservoir on the water side of the bladder. This arrangement allows a person to withdraw considerable water, using a filter arrangement that has only a low flow capacity.

A timer 160 operates the valve 130 at times when the faucet is least likely to be used (opened). The timer switches the valve to pass water from the common port 134 to a drain port 162 for a period such as 20 seconds to backwash, or backflush, the filters. The system uses a minimum amount of water during backwashing. The fiber filters are expected to last for about a year. The initial filter element 136 and the carbon filter 140 each must be changed at intervals such as every month. To change the filters, the valve 130 is first set in a position wherein the common port is connected to the drain, to allow the bladder to empty. Preferably the timer is provided with a manually operated button 164 that produces such complete emptying. Then, the access cover 126 is removed, the filter cartridges 136 and 140 are replaced, and the access cover is replaced.

Ultraviolet light(s) 166 are positioned in the outlet region 170 to kill bacteria that might grow there. The timer preferably has a circuit that energizes a light and/or occasionally makes a sound if the filters are not changed every month, which is sensed by the fact that the button 164 for draining has not yet been depressed after more than a month.

The water pressurizing device such as 52 (FIG. 1) is shown as including a bladder. Other pressurizing device can be used such as a piston that moves in a cylinder that separates pressured water from pressured air or a spring, or a bellows that is biased by pressured air or a spring (e.g. of resilient foam or coiled wire), or a spring that helps move a bladder. Instead of a bladder, a nonelastic flexible bag can be used.

The back washing can be performed by a timer. It also can be performed by a sensor that requires manual operating of a switch, a sensor that operates backwashing after a present number of gallons have flowed, or a sensor that senses less than optimum conditions.

While applicant has described multiple hollow fiber filter elements as a filter arrangement, other types can be used. For example, two parallel and slightly-spaced sheet of microporous material can be wound into a spiral and used, with feed water flowing from the space between sheets to the space outside the sheets. Such pair of sheets can be spiral wound or in other formats. Another filter arrangement is a honeycomb arrangement.

In FIGS. 1 and 5, where feed water from the outside to the inside of the fibers, substantially the entire area of the fiber ends is in communication with the outlet storage region 54 (FIG. 1), 170 (FIG. 5) without any pipes to connect them. This results in saving the amount of water used during backwashing, in that there are no narrow and elongated pipes between the fiber downstream ends (e.g. 180, FIG. 1) and the outlet region 54. This arrangement also reduces the number of pipe connections. Applicant prefers that the diameter at 172 of a circle 182 (FIG. 2) that surrounds the fiber ends be at least 80% of the diameter at 172 of the outlet storage region 54 and preferably with no pipes between them, and that 80% of the area of the circle 182 open to the outlet storage region.

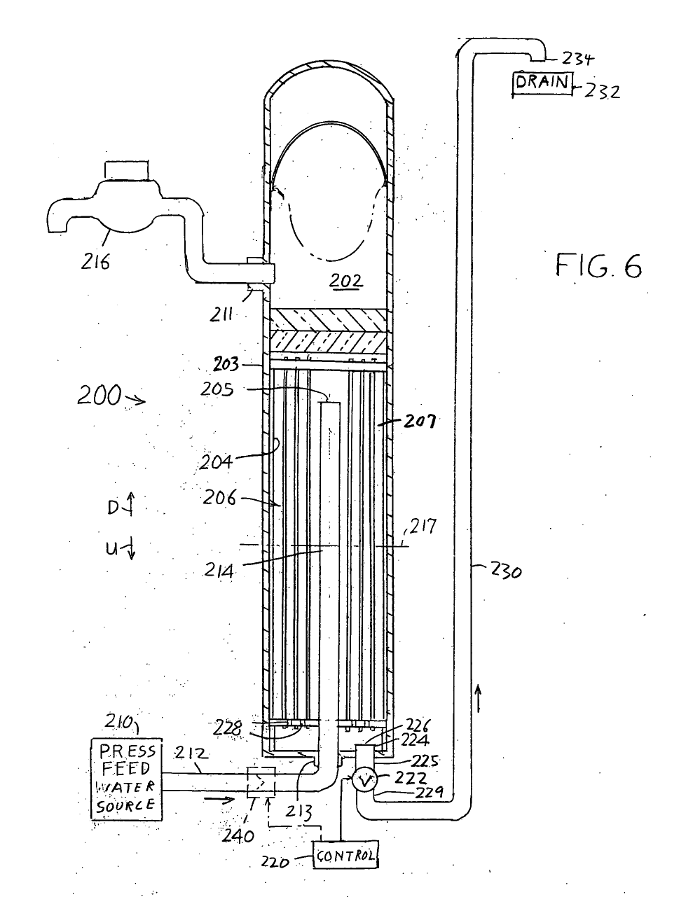

FIG. 6 shows another system 200 that is similar to the system of FIG. 1, except that it provides more water and provides water at a largely constant high pressure for backflushing to a drain. Also, additional and pressurized backflush water is provided without using more of the filtered water lying in the outlet storage region 202 during a backflush. In FIG. 6, a conduit 203 has a sleeve with a passage 204 that contains a filter arrangement 206 comprising multiple fiber filter elements. The system is illustrated with the passage extending vertically, although it could extend horizontally. Pressured feed water from a source 210 flows into an inlet 213 through a feed pipe 212 and then flows through a feed extension pipe 214 that extends partially through the passage 204 with the extension pipe far end 205 which forms an outlet, lying in an upper portion 207 of the passage (downstream D of a passage middle 217). In the usual operation, when water is being drawn from the outlet region 202 to flow from a filtrate outlet 211 to a faucet 216, water flows through the fiber filter elements to the outlet region 202.

When it is time to backflush the system, a control 220 opens a valve 222 that allows water to flow through holes 228 in a disc and into a drain extension pipe 224 at a valve port 225. The pipe 224 has an open end 226 in communication with the passage 204 through the holes 228, and water flows through another valve port 229 and a drain line 230 to a drain 232.

In many cases, a far end 234 of the drain line 230 which opens to the drain, must lie many inches above the filter arrangement 206, such as 18 inches. If all of the backflush water has to flow backward through the fiber filter elements to clean them and then through the passage 204 to clean the outside of fiber elements to sweep away particles on the elements and in the passage, and then upward through the drain line, only a limited amount of water may flow during a backflush. In the system of FIG. 6, filtered water in the outlet storage region 202 flows backward from the inside to the outside of the fiber filter elements to clean the pores of the fiber filter elements. Downward (upstream U) flow along the outside of the fiber filter elements and through the passage, is primarily a flow of feed water (unfiltered) through the passage. Substantially all feed fluid discharged through pipe end 205 flows upstream U through the passage 204 toward the drain during a backflush (rather than forwardly through the filter elements). Since the backflushing lasts only a short period of time, a limited amount of feed water is used for a backflush. At the end of the backflush, the valve 222 is closed. A constriction 240 controlled by the control 220, is preferably placed along the feed pipe 212 to assure that the pressure of water at the extension pipe outlet 205 is always below the pressure of water in the outlet storage region 202 during a backflush.

Thus, the invention provides a water filter system that regularly cleans itself without requiring human intervention. This is accomplished by providing a water pressure device that stores water under pressure at the outlet region of the system, a valve structure at the inlet that can be switched to carry backflushed water to a drain, and a timer or sensor, etc. that controls the valve to switch to the drain mode at intervals. Applicant provides an ultraviolet light source that illuminates the outlet region to kill bacteria and other microscopic life forms that might grow there and that would not be filtered before being dispensed though a faucet.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A water filtering system which includes an inlet for connection to a pressured water source for receiving pressured feed water to be filtered, a filtrate outlet for discharging filtered water to flow out of the filtrate outlet when such flow is unobstructed, and a conduit extending between said inlet and outlet comprising:
a filter arrangement lying in a passage in said conduit, said filter arrangement having at least one filter element with first and second opposite filter surfaces, with said first filter surface coupled to said feed inlet to receive feed water and with said second filter surface coupled to said filtrate outlet to discharge filtered water that has passed forward through the filter;
a water pressurizing device that is coupled to said filtrate outlet and that holds water in an outlet storage region at said filtrate outlet and that pressurizes said water in said outlet storage region;
a valve structure having a first valve port coupled to said conduit and a second valve port coupled to a drain;
a control connected to said valve structure, which operates said valve structure most of the time to close it to not allow water to readily pass from said conduit to said drain, and which operates said valve structure occasionally to open, to back flush said filter arrangement by allowing at least water in said outlet storage region to move backward through said at least one filter element and out to said drain port and which then operates said valve structure to close it.

2. The system described in claim 1 wherein:
said filter arrangement has a downstream end of a predetermined first diameter and said outlet storage region has an upstream end of a diameter that is at least 80% of said first diameter and that is in direct communication with said filter arrangement downstream end.

3. The system described in claim 1 wherein:
said passage has upstream and downstream end portions, and including an extension pipe extending from said feed inlet to said downstream end portion of said passage to discharge feed water into said downstream end portion;
said first valve port of said valve structure is coupled to said upstream end portion of said passage, so when said valve structure is open feed water flows through said extension pipe into said passage downstream end portion to flow upstream through said passage and carry along filtered water that has flowed backward through said at least one filter element into said passage.

4. The system described in claim 3 wherein:
the volume of water that flows during each backflush, from said outlet storage region backward through said filter arrangement, is less than the volume of said passage.

5. The system described in claim 1 wherein:
said control [symbol] that includes a sensor that senses a condition of the system and that switches said valve structure from said first valve position to said second valve position and back to said first valve position in dependence on said sensor.

6. The system described in claim 5 wherein:
said sensor is a timer that operates said valve at preset times.

7. The system described in claim 1 including:
at least one auxiliary filter comprising a bed of contaminant retainer material and a multiplicity of pores, said auxiliary filter lying in said conduit between said feed inlet and said outlet storage region, whereby any water contaminants on said auxiliary filter are kept away from said filtrate outlet.

8. The system described in claim 1 including:
a source of ultraviolet light which illuminates water lying against said water pressurizing device, to kill bacteria that might grow thereon.

9. The system described in claim 1 wherein:
said water pressurizing device is constructed to hold a storage quantity of at least one-half gallon of water in said outlet storage region, and the filtering system passes water through said at least one filter element in said passage at a flow rate of less than one-half said storage quantity per minute from said pressured water source, so when water is drawn from said outlet the water is drawn from water held in said outlet storage region and is pressurized by said water pressurizing device.

10. The system described in claim 9 including:
at least one auxiliary filter that comprises a bed of filtering material and that is connected to said conduit to filter flow to said outlet storage region, said auxiliary filter lying in said bladder.

11. The system described in claim 1 wherein:
said water pressurizing device includes a bladder tank and a bladder that lies in said bladder tank and that surrounds said passage and said filter arrangement in said passage, with pressured air lying on a side of said bladder opposite said feed outlet.

12. The system described in claim 1 wherein:
the volume of water in said outlet region is no more than the volume of said passage which holds said filter arrangement, and the rate at which the last portion of a quantity of water of at least one-half gallon is dispensed from said outlet is controlled primarily by the flow rate of water through said filter elements rather than water stored at said outlet region.

13. A method for supplying filtered water from a source of pressured feed water, comprising:
passing said pressured feed water through an inlet of a conduit and downstream through a passage of the conduit that contains a filter arrangement that includes at least one filter element and forward through the filter arrangement to obtain filtered water, and passing said filtered water into an outlet storage region and through an outlet that opens to said outlet storage region;
storing a quantity of said filtered water under pressure in said outlet storage region;
backflushing said at least one filter element at intervals, including coupling an upstream end portion of said conduit to a drain and flowing filtered water stored under pressure in said outlet storage region backward through said at least one filter element and through said upstream end portion of said conduit to a drain, to back flush said filter element.

14. The method described in claim 13 wherein:
said passage has a downstream end of predetermined diameter and said step of passing said filtered water into an outlet storage region includes passing filtered water through an area with a minimum diameter at least 80% of the diameter of said passage downstream end directly into said outlet storage region.

15. The method described in claim 13 wherein:
said step of backflushing includes flowing pressured feed water directly into a downstream end portion of said conduit and flowing a majority of said feed water that has flowed directly into a downstream end portion, upstream toward said upstream end portion of said conduit and toward said drain, while also flowing said filtered water backward through said at least one filter element into said passage.

16. The method described in claim 13 wherein:
said step of storing includes moving a bladder into a region containing pressured air to store water on a side of said region opposite said pressured air when water is not exiting through said outlet;
withdrawing water from said outlet region at a rate faster than it can flow through said filters, while allowing the bladder to move to reduce the amount of water stored in said outlet region.

17. The method described in claim 13 wherein:
said step of backflushing said filter elements at intervals includes automatically backflushing only between 11:00 PM of one day and 7:00 AM the next day.
